(19) United States
(12) Patent Application Publication
(10) Pub. No.: US 2007/0292575 A1
(43) Pub. Date: Dec. 20, 2007

(54) Machinery And Method For Manufacturing Shaped Pita Bread

(76) Inventors: Alon Ofir, Netanya (IL); Eyal Mor, Rosh HaAyin (IL); Assaf Yosy Habaz, Hadera (IL); Tal Zaltzman, Hadera (IL); Jack Ronen Dvash, Rishon Letzion (IL); Udi Ovadia, Rishon Letzion (IL)

Correspondence Address: FLEIT KAIN GIBBONS GUTMAN BONGINI & BIANCO, 21355 EAST DIXIE HIGHWAY, SUITE 115, MIAMI, FL, 33180, US

(21) Appl. No.: 11/575,401

(22) PCT Filed: Sep. 19, 2005
(86) PCT No.: PCT/IL05/01002

§ 371 Date: May 29, 2007

Related U.S. Application Data
(60) Provisional application No. 60/612,152, filed on Sep. 23, 2004.

(51) Int. Cl. A21C 11/10; A21C 9/08

(52) U.S. Cl. 426/503; 425/142

(57) ABSTRACT

The present invention is a machine and method for producing shaped pieces of dough for manufacturing shaped bakery products. The machine is a “stand alone” machine that can be inserted into any new or existing automatic or semi-automatic production line for producing baked products. The machine is a shaping machine that can be used to cut shaped pieces of dough out of either a continuous sheet or disc shaped pieces of raw dough. The invention includes a specially designed punch assembly, which is adapted to automatically separate the shaped piece of raw dough from the surplus dough. The invention is particularly well suited for the production of shaped pita bread.

### FIELD OF THE INVENTION

The present invention relates generally to pita bread manufacturing processes and more specifically it relates to machines for manufacturing shaped pita pocket bread that can be integrated into automatic or semi-automatic pita manufacturing production lines and methods of using them.

### BACKGROUND OF THE INVENTION

The use and popularity of pita bread has spread around the world from the Middle East, where it originated more than 2000 years ago. The popularity of pita is due to the pocket that is formed inside it as a result of the method by which it is produced. Specifically, when the prepared dough, in the shape of a flat disc or oval, is placed in an oven at high temperature, the heat sears the outer surface forming an outer layer that prevents the gasses released when the dough in the interior of the pita bakes from escaping. As a result, the pita loaf is inflated, separating the upper and lower surfaces. V When the loaf is removed from the oven it cools and again resumes its flat shape, but with its upper part separated from its lower one and sealed around the circumference. The loaf can now be cut and the interior pocket filled with any desired type of food resulting in a sandwich that is both convenient to prepare and also to eat.

Ever increasing sales of pita bread and especially because of its advantages in the fast food market have inspired a great deal of work that has resulted in the development of specialized fully and semi automatic production lines that are capable of producing hundreds and even thousands of loaves an hour. In addition a great deal of effort has been devoted in the prior art to improving the production methods to obtain a more standardized product and overcome problems inherent to the baking of the pita such as rupturing of the outer skin by the expanding gases trapped inside. One of the steps in the production of pita is the production of the round-shaped discs that are to be introduced into the oven. This step can be carried out in one of two ways. In the first method, which is almost universally employed and described for example in U.S. Pat. No. 4,597,979, the dough is formed into uniformly sized balls, which are spaced apart on a conveyor belt. The balls then travel on the belt under a series of rollers which flatten them into the desired thickness and oval shape. In the second method, the dough is feed through a series of rollers as it advances through the production line on a conveyor system. Eventually the dough is reduced to a continuous sheet having the desired thickness. Finally pieces having the desired shape are cut out of the sheet of dough. The cutting is typically done by a method described, for example in U.S. Pat. No. 4,800,807. In this method the sheet of dough passes under a continuously rotating cylinder that has a plurality of circularly shaped blades, which cut the dough into the desired disc shaped pieces. In U.S. Pat. No. 4,202,911 is described a production line in which a reciprocating cutter head with a number of oval cutting sleeves is used to cut the pieces out of the sheet of dough. After passing under the roller or being stamped out by the action of the cutting head, the discs of dough remain separated from, but encircled by the remainder of the sheet. This surplus dough must be removed from the conveyor belt before the dough enters the oven for baking.

In U.S. Pat. No. 4,202,911 it is mentioned that the dough can be cut in other shapes, e.g. square or triangular; however, to the best of the inventors' knowledge, commercially produced pita bread always has a round shape. This limits bakeries and bread manufacturers to traditional markets and does not allow them to target more market segments and increase market share by altering conventional pita bread shapes.

It is an object of the present invention to provide a machine for cutting shaped pieces out of a disc of dough, automatically separating the desired pieces from the surplus dough, and collecting the surplus dough to be used again in the dough pulp.

It is another object of the invention to provide a machine for cutting shaped pieces out of a disc of dough, automatically separating the desired pieces from the surplus dough, and collecting the surplus dough to be used again in the dough pulp that can be integrated into any existing pita bread assembly line.

It is another object of the present invention to provide a method of manufacturing shaped pita pocket bread having diverse shapes.

Further purposes and advantages of this invention will appear as the description proceeds.

### SUMMARY OF THE INVENTION

In a first aspect the invention is a machine for creating pieces of dough having a desired shape from unshaped raw dough. The machine comprises:
(a) a supporting frame;
(b) one or more punch assemblies each comprising one cutting edge having the desired shape on its bottom surface;
(c) one or more vertical piston assemblies to move the punch assemblies in a vertical direction;
(d) one or more horizontal piston assemblies to move the punch assemblies in a horizontal direction;
(e) a horizontal planar surface on which the unshaped raw dough is positioned in order to be shaped by the punch assembly;
(f) conveyor belts to transport the unshaped raw dough to the surface, to transport the pieces of dough having a desired shape to machines for further processing, and for transporting the surplus dough to be recycled;
(g) one or more sensors to determine the position of the unshaped raw dough relative to the center of the punch assemblies;
(h) a source of air at positive pressure;
(i) a source of suction; and
(j) a control system.

Each of the punch assemblies comprises one or more arrays of holes, which is connected to the source of air at positive pressure and/or the source of suction. By applying suction through the holes, the dough can either be held to the bottom surface of the punch assembly; or by applying air at positive pressure, the dough can be released from the bottom surface of the punch assembly.

In one embodiment of the machine of the invention the cutting edge divides the bottom surface of the punch assembly into two areas: an inner area, which corresponds to the shape and size of the shaped piece of dough, and an outer area, which corresponds to the surplus dough. The array of holes of the inner area can be activated independently of the array of holes of the outer area. The inner area of the bottom of the punch can be cut out and there is only an array of holes in the outer area. The bottom of the punch area can comprise one or more additional cutting edges located within the interior area. Each of the areas surrounded by the additional cutting edges comprises an array of holes.

In another embodiment of the machine of the invention, the cutting edge defines the outer border of the punch assembly. In this embodiment the punch assembly is divided into two parts, and the machine comprises, for each of the one or more punch assemblies, two piston assemblies for separating and reuniting the parts of the punch assembly. One or more low relief figures having the shape and orientation of the cutting edge on the bottom of the corresponding punch assembly are located on the horizontal planar surface centered under each punch assembly.

In all embodiments of the machine either the entire punch assembly or the component of the punch assembly comprising the cutting edge can be replaced with either another punch assembly or another component comprising a cutting edge having a different shape.

The machine of the invention can be modified to accept either raw dough in the form of individual pieces shaped like round discs, in which case each of the horizontal and vertical piston assemblies is activated independently; or as a continuous sheet.

The machine of the invention is preferably used for the production of pita bread and the machine can be integrated into any new or existing automatic or semi-automatic pita manufacturing production line; However, it can be easily adapted to be integrated into any existing automatic or semi-automatic bakery product manufacturing production line; including lines for the production of pizza, cookies; biscuits, tortias, fucacha, jabetta, pasta, mallach, fatut, and unleavened bread (matza).

In another aspect the invention is a method for creating pieces of dough having a desired shape from unshaped raw dough. The method comprises the steps of:
(a) providing an automatic or semi-automatic bakery product manufacturing production line;
(b) inserting a machine according to the invention into the line after the flattening machine, which creates flattened unshaped raw dough;
(c) activating the horizontal piston assemblies to move the punch assemblies over the horizontal planar surface;
(d) activating the vertical piston assemblies in response to a signal from the positioning sensor to move the punch assemblies downwards towards the horizontal planar surface, thereby cutting the unshaped raw dough into shaped pieces of raw dough and surplus dough;
(e) activating the punch assemblies, the corresponding vertical and horizontal piston assemblies, the source of air at positive pressure, and the source of suction to separate the pieces of dough having a desired shape from the surplus dough and transporting the shaped pieces to the next machine of the production line for further processing and transporting the surplus dough to be recycled.

According to one embodiment of the method of the invention, the cutting edge divides the bottom surface of the punch assembly into an inner area, which corresponds to the shape and size of the shaped piece of dough and an outer area, which corresponds to the surplus dough. The array of holes in the inner area can be activated independently of the array of holes in the outer area and step (e) comprises:
(i) causing air at a positive pressure to flow through the array of holes of the inner area;
(ii) activating the vertical piston assembly causing the punch assembly to be pulled upwards, the air flow thereby causing the shaped dough to separate from the punch assembly and remain on the horizontal planar surface;
(iii) simultaneously with step (i), activating the source of suction to cause negative pressure on the back side of the surplus dough outside the cutting edge, thereby causing it to adhere to the punch assembly;
(iv) as the punch assembly is raised off the horizontal planar surface, activating the horizontal piston assembly to move the punch assembly over the conveyor belt that transports the surplus dough to a storage vessel or machine for recycling;
(v) when the punch assembly is positioned over the conveyor belt, disconnecting the suction source from the array of holes of the outer area and causing air at a positive pressure to flow through them, thereby causing the surplus dough to be released from the punch assembly and to drop onto the conveyor.

In another embodiment the inner area is cut out and there is only an array of holes in the outer area and step (e) comprises:
(i) activating the vertical piston assembly causing the punch assembly to be pulled upwards, thereby causing the shaped dough to separate from the punch assembly and remain on the horizontal planar surface;
(ii) simultaneously with step (i), activating the source of suction to cause negative pressure on the back side of the surplus dough outside the cutting edge, thereby causing it to adhere to the punch assembly;
(iii) as the punch assembly is raised off the horizontal planar surface, activating the horizontal piston assembly to move the punch assembly over the conveyor belt that transports the surplus dough to a storage vessel or machine for recycling;
(iv) when the punch assembly is positioned over the conveyor belt, disconnecting the suction source from the array of holes of the outer area and causing air at a positive pressure to flow through them, thereby causing the surplus dough to be released from the punch assembly and to drop onto the conveyor.

The order of the activation of the positive pressure air flow and suction can be changed in order to cause the surplus dough to remain on the horizontal planar surface and the shaped dough to be transferred to another conveyor belt According to another embodiment, the shaped pieces of dough can be provided with cut out areas by providing the punch assemblies with one or more additional cutting edges located within the interior area. The area surrounded by each of the additional cutting edges comprises an array of holes.

In another embodiment of the method of the invention the cutting edge defines the outer border of the punch assembly. In this case the punch assembly is divided into two parts and the machine comprises, for each of the one or more punch assemblies, two piston assemblies for separating and reuniting the parts of the punch assembly. According to this embodiment, step (e) of the method comprises:
(i) activating the two piston assemblies to separate the two parts of the punch assembly, thereby pushing the surplus dough off the horizontal planar surface onto a conveyor belt that transports the surplus dough to a storage vessel or machine for recycling;
(ii) activating the two piston assemblies to reunite the two parts of the punch assembly;
(iii) activating the source of suction to cause negative pressure on the back side of the shaped dough inside the cutting edge, thereby causing it to adhere to the punch assembly;
(iv) activating the vertical piston assembly causing the punch assembly to be pulled upwards;
(v) activating the horizontal piston assembly, thereby moving the punch assembly to a position over a conveyor belt that will transport the shaped dough to the next machine in the production line;
(vi) when the punch assembly is over the conveyor belt, activating the vertical piston assembly to lower the punch assembly close to the surface of the conveyor belt;
(vii) when the punch assembly is positioned over the conveyor belt, disconnecting the source of suction and causing air at a positive pressure to flow through the array of holes in the punch assembly, thereby causing the shaped dough to be released from the punch assembly onto the conveyor.

According to the method of the invention, the raw dough can comprise either pieces shaped like round discs, in which case each of the horizontal and vertical piston assemblies is activated independently; or a continuous sheet, in which case all of the horizontal piston assemblies and all of the vertical piston assemblies are activated in unison.

The method of the invention is particularly adoptable for use in the production of pita bread.

All the above and other characteristics and advantages of the invention will be further understood through the following illustrative and non-limitative description of preferred embodiments thereof, with reference to the appended drawings.

### BRIEF DESCRIPTION OF THE DRAWINGS

FIG. 1 is a block diagram schematically showing a prior art production line 10 for producing pita bread;

FIG. 2 shows a small sample of different shapes of pita bread that can be made with the shaping machine of the invention;

FIG. 3 and FIG. 4 show different views of a preferred embodiment of a shaping machine of the invention;

FIGS. 5A, 5B, and 5C show different views of different ways of transferring the raw dough to the cutting surface on top of the bridge;

FIGS. 6A to 6D are different views showing details of the punch assembly;

FIGS. 6E and 6F show front and back views of another embodiment of the base plate of the punch assembly;

FIG. 7 and FIG. 8 are different views showing schematically another embodiment of the shaping machine of the invention;

FIG. 9A to FIG. 9E schematically shows the steps in the shaping procedure using the shaping machine of FIG. 7 and FIG. 8;

FIG. 10A shows an embodiment of the punch assembly of the invention that is constructed to provide shaped bakery products comprising cut out areas;

FIG. 10B shows a shaped pita made using the punch assembly of FIG. 10A; and

FIG. 11 and FIG. 12 show different configurations of an embodiment of the shaping machine of the invention used to cut the shaped pieces of dough out of a continuous sheet of raw dough.

### DETAILED DESCRIPTION OF PREFERRED EMBODIMENTS

The present invention is a machine to be inserted into a standard production line for producing baked products. Any existing automatic or semi-automatic production line can be easily adapted to accommodate the machine of the invention. The machine is a shaping machine that can be used to cut shaped pieces of dough out of either a continuous sheet or disc shaped pieces of raw dough. In the following description, the invention will be illustrated in reference to a production line for pita bread; however it is to be understood that the machine can be modified mutatis mutandis to be used to shape the dough for other bakery products, e.g. pizza, biscuit, cookie, tortias, fucacha, jabetta, pasta, mallach, fatut dough, and unleavened bread (matza). The shaped pieces of pita dough can be supplied to the customer as baked pita loafs, ready to be filled and eaten, or as frozen or semi-baked dough to be baked at the customer's convenience.

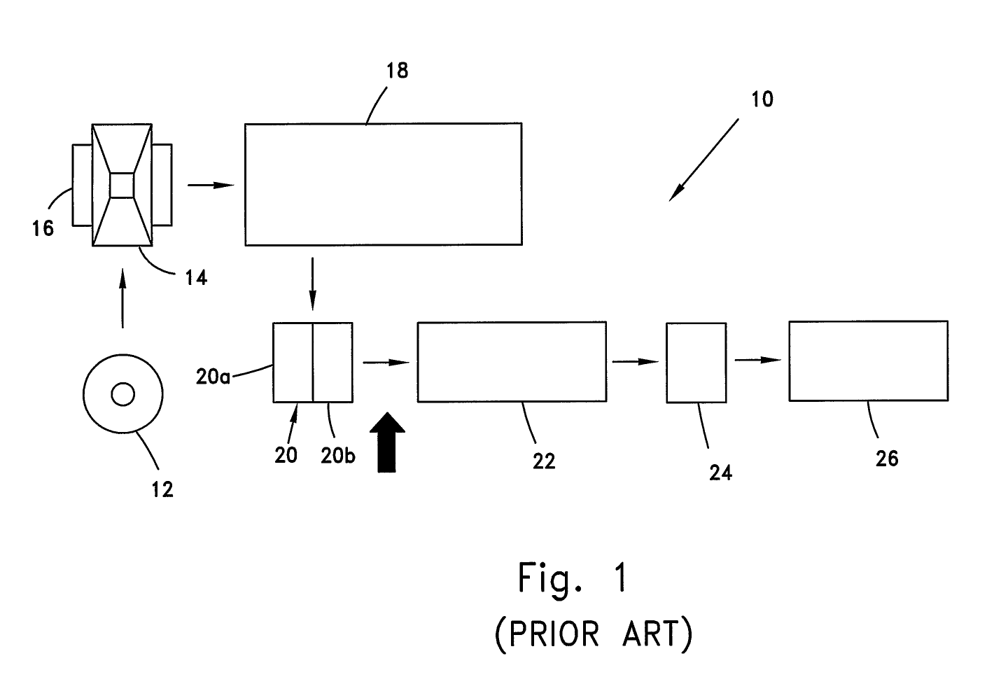

In FIG. 1 is a block diagram schematically showing a prior art production line 10 for producing pita bread. The bulk dough is made by mixing flour, yeast, water and the other ingredients in mixer 12. From the mixer, the bulk dough is introduced through hopper 14 into a machine 16 i n which the dough is divided into small equal portions, typically by weight, and each portion is rolled into a ball. The balls of dough are then introduced into a first proofing chamber 18. From proofing chamber 18 the balls c of dough are transferred to a flattening machine 20 where they pass under rollers and are flattened to form discs of uniform thickness and dimensions. Flattening machine 20 actually comprises two separate machines, or sets of rollers 20A and 20B. The first set of rollers flattens the balls of dough into oval shaped pieces and the second set, at right angles to the first flattens the oval shaped pieces into discs having the desired dimensions. After flattening the discs of dough enter a second proofing chamber 22 and from there pass through tunnel oven 24 and onto cooling conveyor 26, where they are cooled down before being packaged. The bold arrows show the direction of motion of the dough through the production line.

No conveyor belts, elevators, etc. for moving the dough through the line are shown in FIG. 1, but it is understood that these standard features are present. The description applies to both semiautomatic and automatic lines, the difference being that in a fully automatic line, all the machines shown are connected by conveyor belts or other suitable conveyance means and the dough moves through the system from the hopper to the cooling conveyor without the need for human intervention.

As is well known in the art, although the speed of the entire line can be adjusted, the relative speed of all the machines must be kept constant in order to allow for continuous operation of the production line. In order to reduce the length of the machines, while allowing sufficient time to complete the specific operation, the path of the dough through the machine is increased folding the belt back and forth accordion style. In this way, for example, the dough travels back and forth in the proofing chambers progressively moving lower in the chamber on each pass until it has remained in the chamber the required amount of time. The production line is also provided with control means to maintain proper flow of the dough through the line; control production conditions, such as temperature and humidity; and warn of, and if possible correct, any problems that arise.

The shaping machine of the invention is inserted into the pita production line at the location indicated by the dark arrow in FIG. 1, just before the second proofing chamber. As will be described in detail hereinbelow, the machine of the invention comprises one or more dies fixed to reciprocating pistons. As the discs of flattened dough leave the flattening machine 20, the piston descends, cutting the desired shape of the final pita loaf out of the disc of dough. As the piston rises, it lifts the surplus dough with it, leaving the shaped dough on the conveyor belt to continue into proofing chamber 22. The surplus dough is moved to the side, released onto a conveyor, and transported to a collection vessel to be reintroduced into hopper 14 or mixer 12.

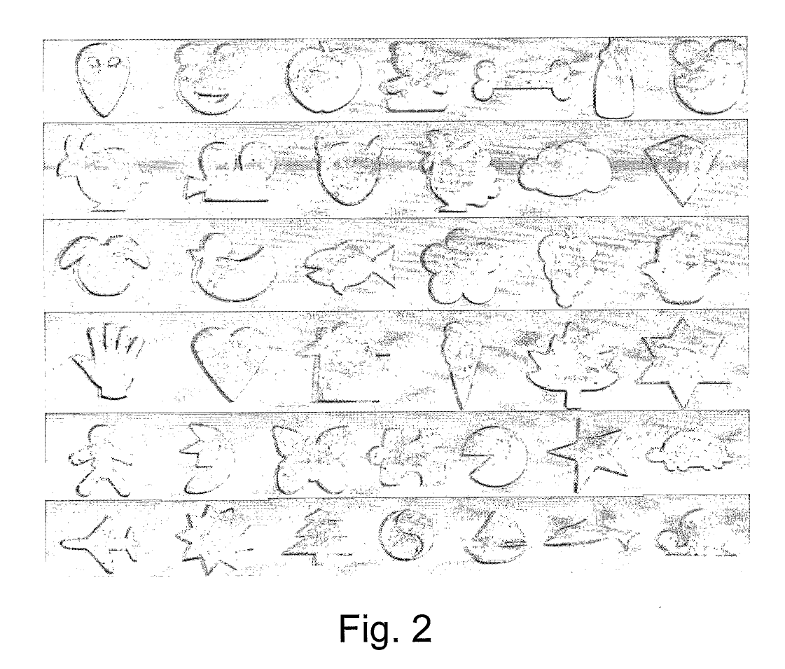

In FIG. 2 are shown a small sample of the different shapes of pita made by the inventors. The dies can be designed to have any shape, but preferably do not have sharp angles, corners, or narrow sections. This is because the dough in regions having these shapes bakes through very rapidly. Therefore the gases that should be emitted by relative slow cooking of the interior are not produced, the outer surfaces do not separate in the oven, and the pocket does not develop properly making at least a part of the pita bread unsuitable for sandwich making. A similar problem arises if the die presses down to hard on the dough. In this case the baked product has the appearance of pita bread, but lacks the characteristic pocket.

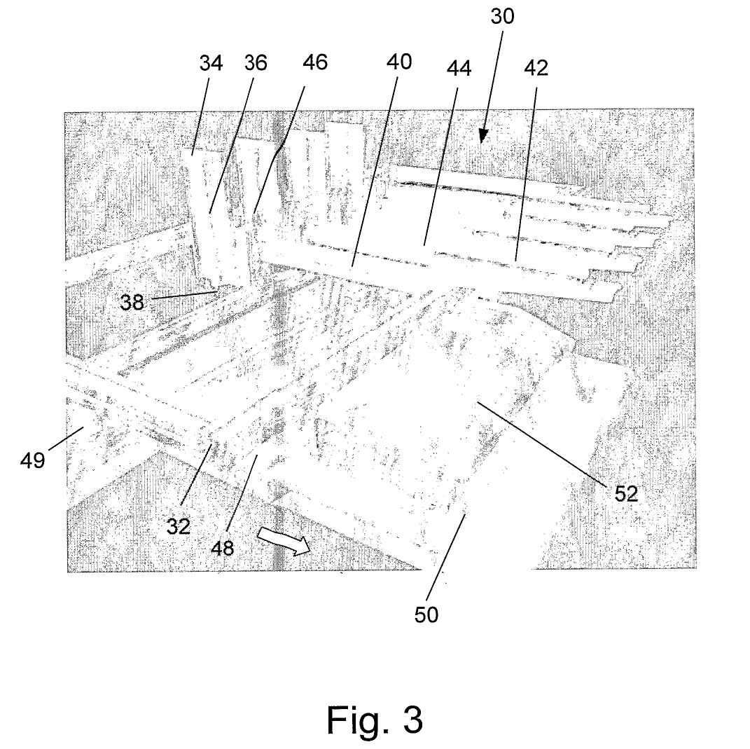

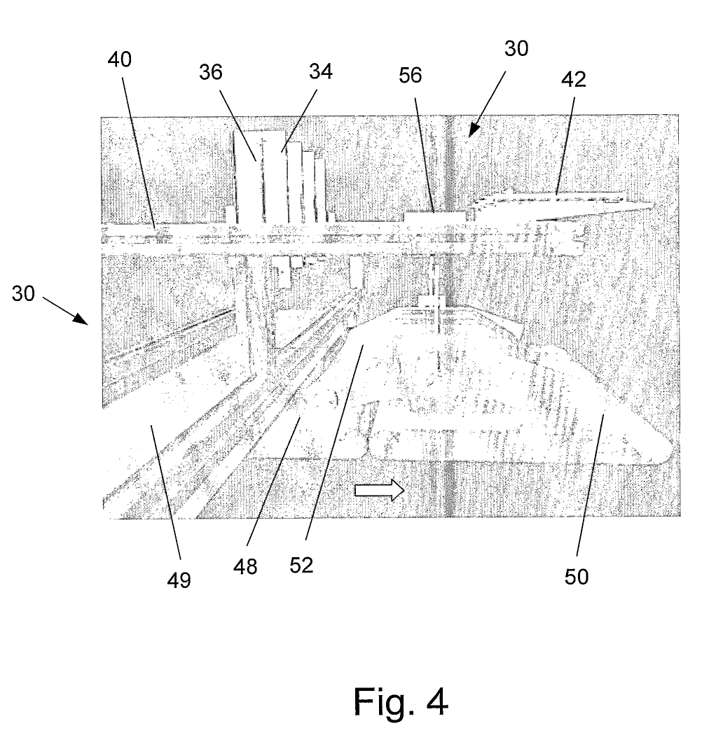

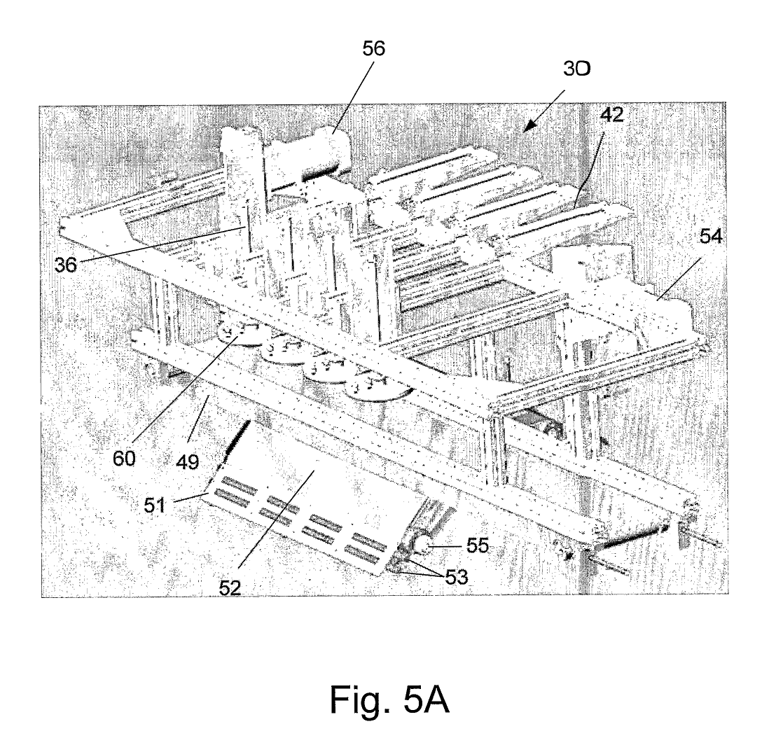

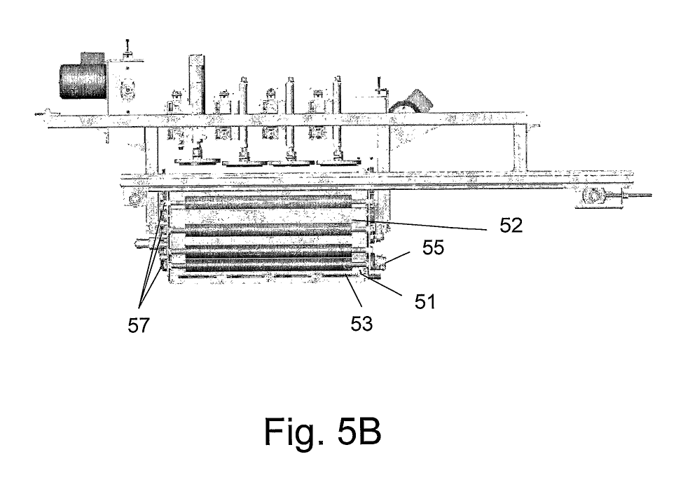

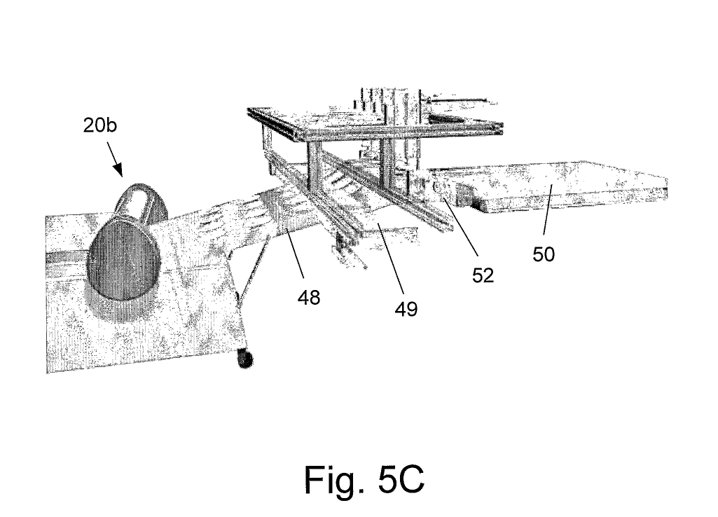

FIG. 3, FIG. 4, FIG. 5A, and FIG. 5B show different views of a preferred embodiment of a shaping machine 30. The shaping machine 30 of the invention comprises a support frame 32, which supports a number of horizontal rails 40. The machine 30 shown in the figures has four horizontal rails 40, but this is merely for illustrative purposes and the actual number will depend on the dimensions and throughput of the production line.

A piston assembly 42 is attached to one end of each horizontal rail 40. The piston rod 44 is shown withdrawn into the cylinder of piston assembly 44 for clarity; but, in operation, the end of rod 44 extending out of the piston is connected to connector 46 on carriage 34. Carriage 44 is mounted on horizontal rail 40 with a suitable wheel or bearing assembly to reduce friction, thereby enabling it to be easily moved on the rail. Activating the piston assembly 42 in a reciprocating manner will cause carriage 34 to move back and forth on horizontal rail 40.

Mounted vertically on each of the carriages is a piston assembly 36. Attached to the piston rod 38, extending downwards from piston assembly 36 is a circular punch assembly 60 (shown clearly only in FIG. 5A). Activating the piston assembly 36 in a reciprocating manner will cause punch assembly 60 to move up and down. Each of the four horizontal piston assemblies 42 and corresponding vertical piston assemblies 36 are activated individually according to a signal received from a suitable optical or mechanical sensor that indicates when the disc of raw dough will be in exact position under the punch assembly 60 when it reaches its lowest position. This system guarantees that the maximum accuracy in shaping the dough is achieved and that there will never be lack of synchronization between the discs of dough being fed to the shaper and the up and down motion of the die. The piston assemblies can be hydraulic (water or oil) or, as is preferred in the environment of a food production line, pneumatic.

FIGS. 5A, 5B, and 5C show different views of different ways of transferring the raw dough to the cutting surface on top of the bridge. Referring to FIG. 5A, the discs of dough travel on conveyor 48 from the second flattening machine 20B. When they arrive at machine 30, they glide over a thin plastic or metal plate 51 and onto a set of rollers 53 which move them, without damage onto the conveyor belt of bridge 52. The rollers 53 are rotated by pulleys connected to the shaft of motor 55 that drives the conveyor belt of the bridge. Shown in FIG. 5B is an embodiment in which one or more rollers 57 are placed over belt 52 and spaced apart from it so that the roller lightly contacts the upper surface of the disc of raw dough. Rollers 57 are used if the angle with the horizontal becomes so great that the frictional force between the dough and the belt will not hold the dough in place. FIG. 5C shows an embodiment in which conveyor belt 48, which comes directly from the second flattening machine 20b, is oriented such as to deliver the discs of raw dough directly to the cutting surface on the top of bridge 52. The arrangements shown in FIGS. 5A to 5C are typical illustrative examples of many others that can be devised depending upon, amongst other considerations, the amount of available space in the production line.

The set of pistons 42 pull the carriages 34 backwards such that, when an uncut disc of dough arrives on the bridge 52, piston assembly 36 is activated causing piston rod 38 to descend. The die attached to the bottom of cutting assembly 60 is pressed into the dough, thereby cutting out the desired shape. As soon as the dough has been shaped, piston rod 38 begins to rise. As will be explained hereinbelow, the shaped dough remains on the conveyor, moves off the bridge 52 and onto conveyor 50, which transports it to the next machine e.g. a proofing chamber 22. The surplus dough is held in the punch assembly 60. As soon as the upwardly moving punch assembly clears the shaped pita on bridge 52, piston assembly 42 pushes carriage 34 moving it from over bridge 52 to a position over conveyor belt 49. When the carriage 34 is over conveyor belt 48, the surplus dough is released from punch assembly 60 and drops onto the conveyor 49, which transports it either directly to hopper 14, to mixer 12, or to a collection vessel (not shown in the figures). The bridge 52 serves at least two functions: firstly, standard conveyor belts, such as 48, 49, and 51 are too flexible and do not provide a suitable surface for punching out the shapes therefore the bridge 52 is especially designed for this purpose; secondly, the height difference between the various conveyors is needed to maintain the correct timing of the shaping operation.

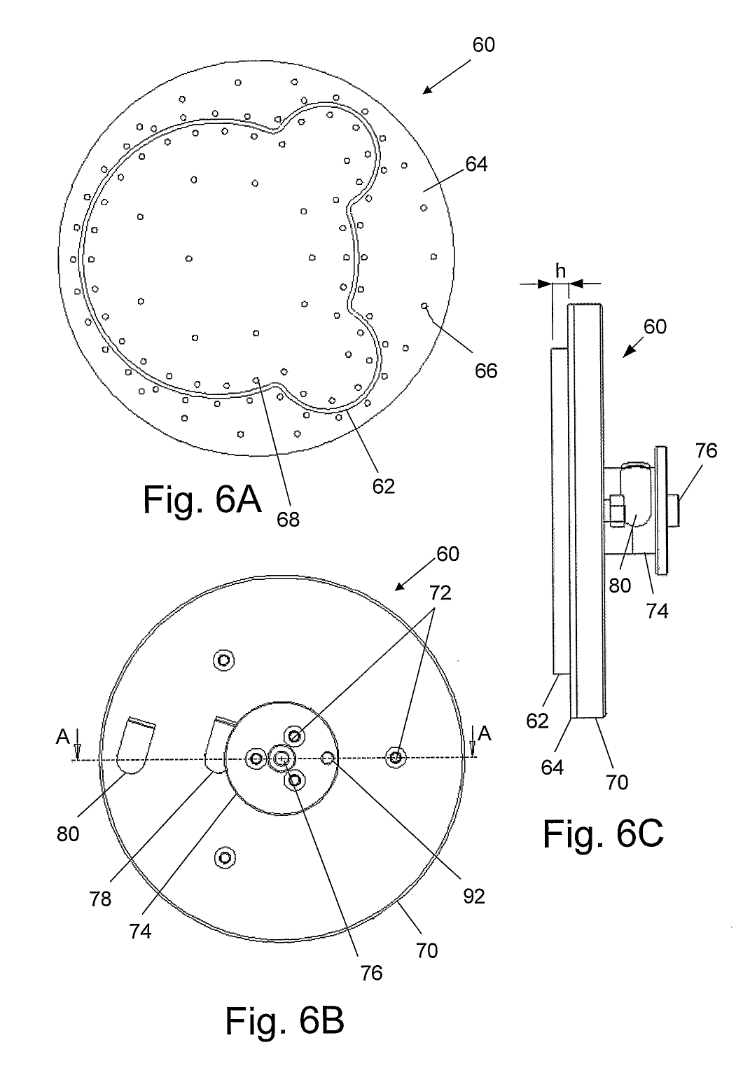

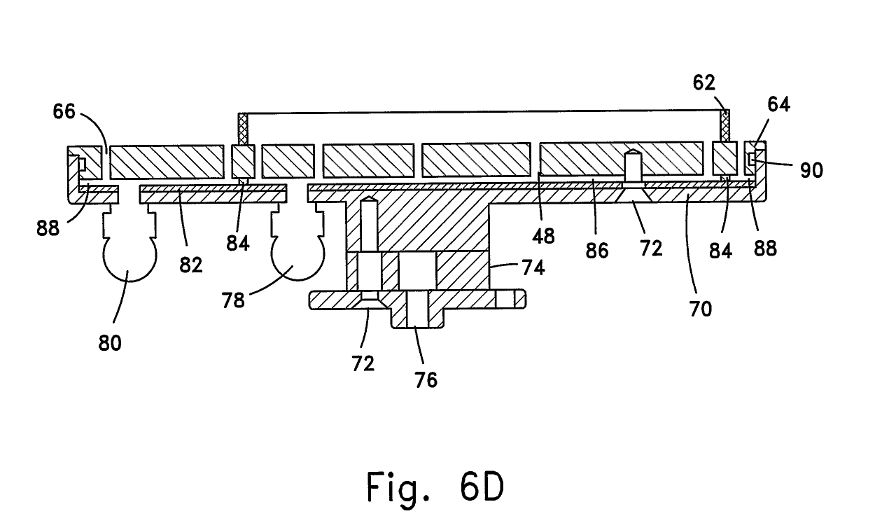

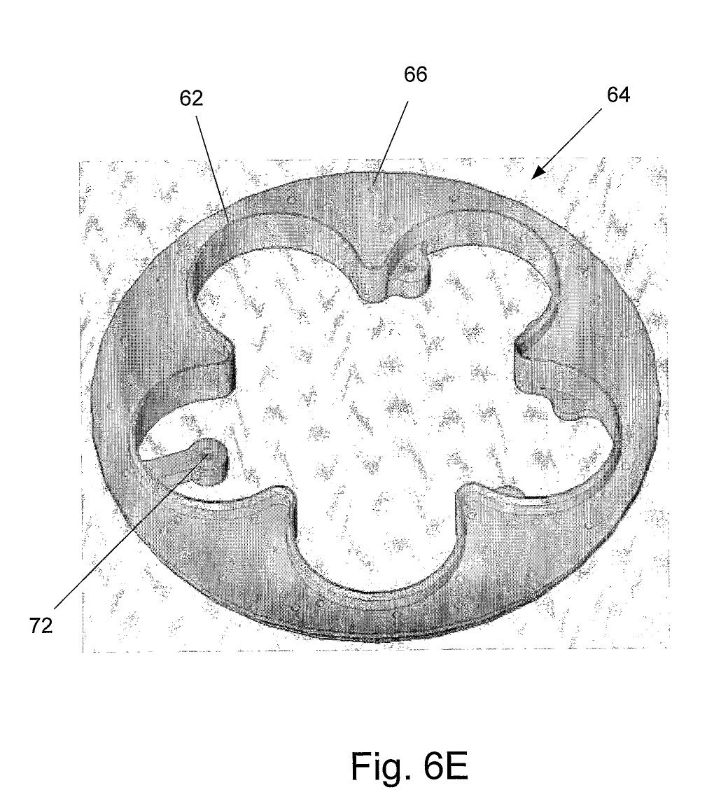

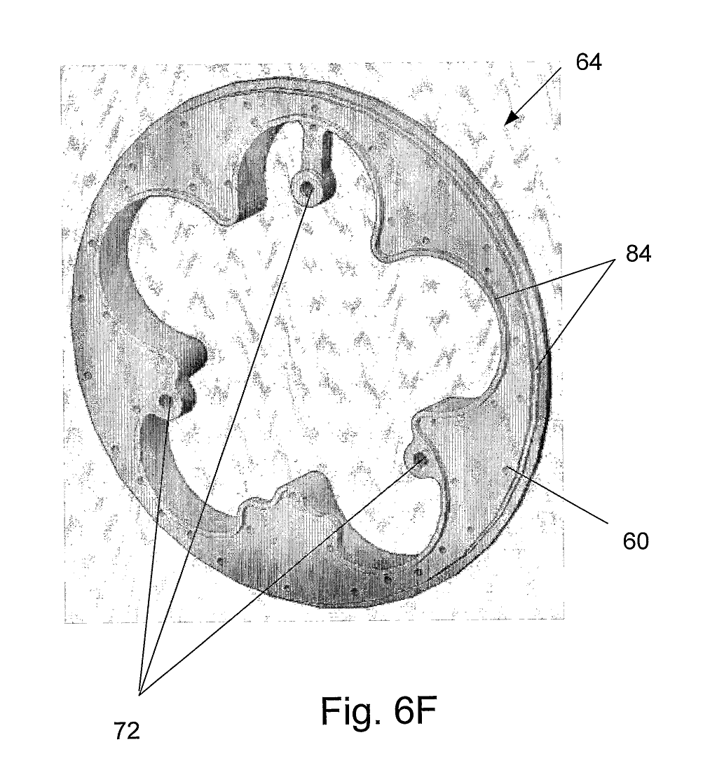

FIGS. 6A to 6D are different views showing details of punch assembly 60. FIG. 6A is a front view showing the surface of the punch assembly that engages the dough. Face plate 68 has a circular shape having diameter slightly larger than that of the disc of dough that is to be shaped. The thin blade shaped cutting edge 62 is attached to base plate 64. Cutting edge 62 is a continuous strip that defines the shape of the pita bread to be cut out of the disc. The dough inside cutting edge 62 will become the shaped pita bread and the dough outside is surplus dough that is collected and recycled. Base plate 64 comprises an array of holes whose function will be explained in respect to FIG. 6D. The array of holes is divided by cutting edge 62 into two separate sets, which are identified as external holes 66 and internal holes 68.

FIG. 6B is a back view of the punch assembly 60. Seen in this figure are back plate 70, assembly screws 72, and flange assembly 74. In the center of the flange assembly, located at the center of the punch assembly, is a threaded hole 76 used to connect the punch assembly 60 to the piston rod 44. Also shown in FIG. 6B are inlet fitting 78, which is in fluid contact with internal holes 68, and outlet fitting 80, which is in fluid contact with external holes 66.

FIG. 6C is a side view of punch assembly 60. In this figure it can be seen how cutting edge 62 projects above the upper surface of base plate 64. The height of cutting edge 62 should be essentially equal to and preferably slightly larger than the thickness of the unbaked disc of dough so that the dough will not be compressed when it is shaped and the process of formation of the pocket during baking will not be disrupted.

FIG. 6D is a cross-sectional view taken along line A-A in FIG. 6C. From this figure it can easily be seen how the parts of the punch assembly are arranged and held in place by assembly screws 72. A rubber gasket 82 is positioned between bottom plate 70 and base plate 64. Projecting outward from the bottom of base plate 64 is a short, continuous rubber gasket 84 that is symmetrically sized, shaped, and oriented with the cutting edge 62 on the top side of the bottom plate 70. When the punch assembly 60 is assembled, the projection 84 presses against the gasket, forming a tight seal that helps define two thin spaces between back plate 70 and base plate 64. Internal space 86 provides for fluid contact between inlet fitting 78 and the set of internal holes 68. External space 88 provides for fluid contact between inlet fitting 80 and the set of external holes 66. An o-ring 90 completes the seal between base plate 64 and back plate 70.

Referring to FIG. 6D, the operation of the shaping machine 30 can now be described. Inlet fittings 78 and 80 are connected, through appropriate tubing and valves to an air compressor. Inlet fittings 80 is also connected to a vacuum pump so that air can either be selectively supplied to or removed from external space 88. While punch assembly is descending towards the unshaped disc of dough on bridge 52 (or at the instant it reaches its lowest point or immediately thereafter when it just begins to rise) air at a positive pressure is caused to flow through inlet fitting 78 and through internal holes 68. The positive air pressure on the back side of the dough inside the cutting edge 62 causes it to separate from the punch assembly and the shaped pita dough remains behind on the belt as punch assembly 60 is pulled upwards. At the same time that air is introduced through inlet fitting 78, the vacuum pump is connected to inlet fitting 80 causing a negative pressure on the back side of the dough outside the cutting edge 62 causing it to adhere to the punch assembly 60. When the punch assembly has been moved until it is positioned over conveyor 48, the vacuum pump is disconnected from inlet fitting 80 and the compressor connected. The resulting positive pressure causes the surplus dough to be released from punch assembly 60 and it drops onto conveyor 48.

FIGS. 6E and 6F show front and back views respectively of another embodiment of the base plate 64 of the punch assembly. In this embodiment, the interior area of base plate 64, which corresponds to the shape and size of the shaped piece of dough to be cut out of the disc of raw dough, is cut out. After pressing the punch assembly into the raw dough, the shaped piece remains on the cutting surface when the punch assembly is raised. In this embodiment there is only an array of outer holes 68, which are used to attach and release the surplus dough from the cutter assembly. The back plate and operation of the cutter assembly is the same mutatis mutandis to the embodiment of the punch assembly described with respect to FIGS. 6A to 6D.

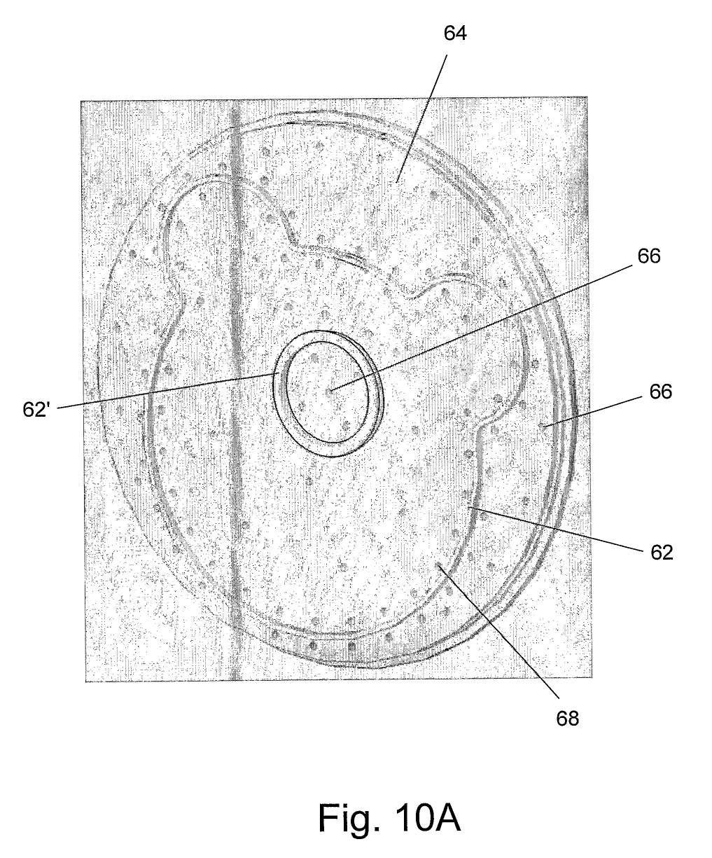

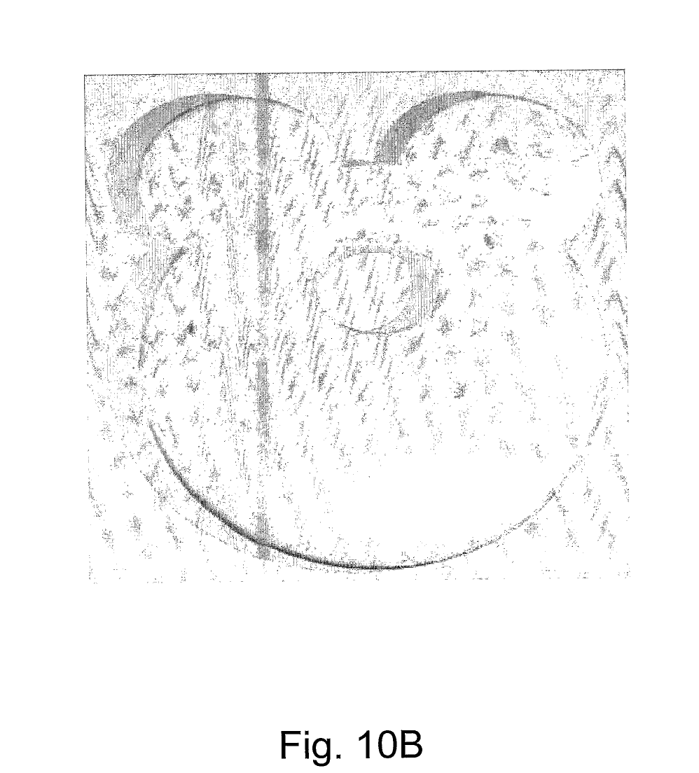

The punch assembly of the invention can be constructed to provide shaped bakery products comprising cut out areas. For example, a second cutting edge 62′ can be provided as shown in FIG. 10A. The dough inside this cutting edge is to be removed; therefore, the holes inside cutting edge 62′ are in fluid contact with the array of external holes 66. In FIG. 10B is shown a shaped pita made using the punch assembly of FIG. 10A.

The shaping machine described hereinabove can also be designed to work in the opposite manner, i.e. such that the surplus dough remains on the bridge and is transferred to a conveyor that takes it to be recycled while the shaped pieces are kept attached to the punch assembly by the vacuum and transferred to another conveyor belt where they are released.

In order to change the shape of the pita being produced, either the entire punch assembly can be disassembled from the piston assembly 36 and replaced or, referring to FIG. 6D, those of screws 72 that hold the base plate 64 to the back plate 70 can be removed. When this is done, the base plate 64 can be replaced with one having a differently shaped cutting edge 62. The second method is preferred; since this can be done with the base plate attached to the piston assembly 36 and does not require disconnecting and reconnecting the air hoses.

The shaping machine of the invention is also supplied with a control system to orchestrate the timing of the motion of the pistons, supply bursts of air and/or vacuum to inlet fittings 78, 80, coordinate the speed of the conveyors with the overall speed of the entire production line, etc. The control system preferably includes data or command input means, processing unit, information storage means, and display means. The shaping machine also comprises: motors to drive the conveyors; pumps; automatic valves, either pneumatic or electronic; optical or mechanical sensors to determine the location of the discs of unshaped dough, pressure sensors; other sensors, e.g. sensors to measure the speed of motion of the belts; tubing to connect the pistons to the compressor that drives them; and tubing to connect the inlet fittings on the punch assembly to the compressor or vacuum pump. Because all of these components all standard items well known in the art and can be supplied in many alternative embodiments that are familiar to skilled persons they are not shown in any of the figures or described herein in any detail.

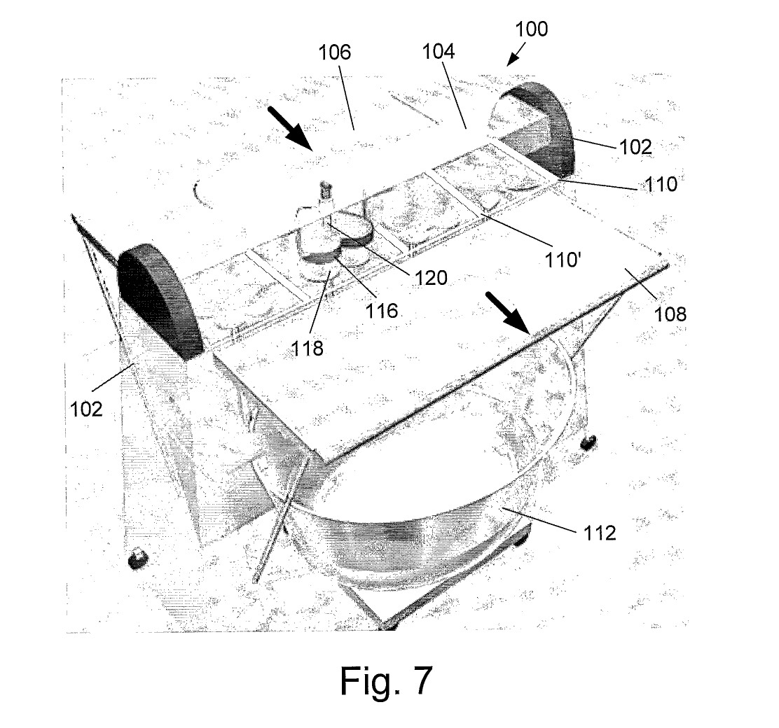

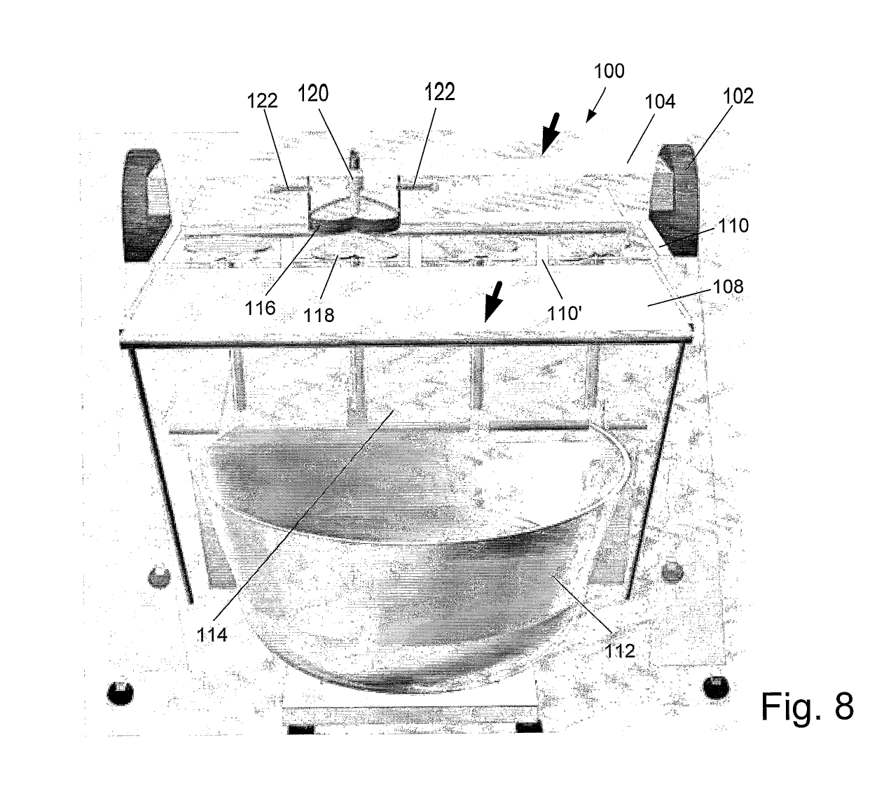

FIG. 7 and FIG. 8 are different views showing schematically another embodiment of the shaping machine of the invention. Many of the elements of shaping machine 30 described hereinabove are present mutandis mutatis in shaping machine 100 of the presently described embodiment. For this reason only the principal distinguishing features of machine 100 will be shown in the figures and described in detail. As in the case of machine 30, the machine 100 can be designed to shape several pita loafs at essentially the same time. For illustrative purposes the machine shown in the figures has four punch assemblies, only one of which is shown in order to simplify the drawings.

Referring now to FIG. 7 and FIG. 8, shaping machine 100 is comprised of a support frame 102 and an upper support 104. At the upper part of support frame 102 is attached a moving conveyor belt 106, which brings the flattened discs of dough that are to be shaped from the second flattening machine to the cutting table; a stationary cutting table 110; and a second moving conveyor belt 108, which transports the shaped dough towards the proofing chamber At the bottom of the machine is a collection vessel 112. Between the cutting table 110 and the collection vessel 112 are a set of conveyor belts 114 that collect the surplus dough, which is pushed off table 110 in a manner to be described, and transport it to the collection vessel 112.

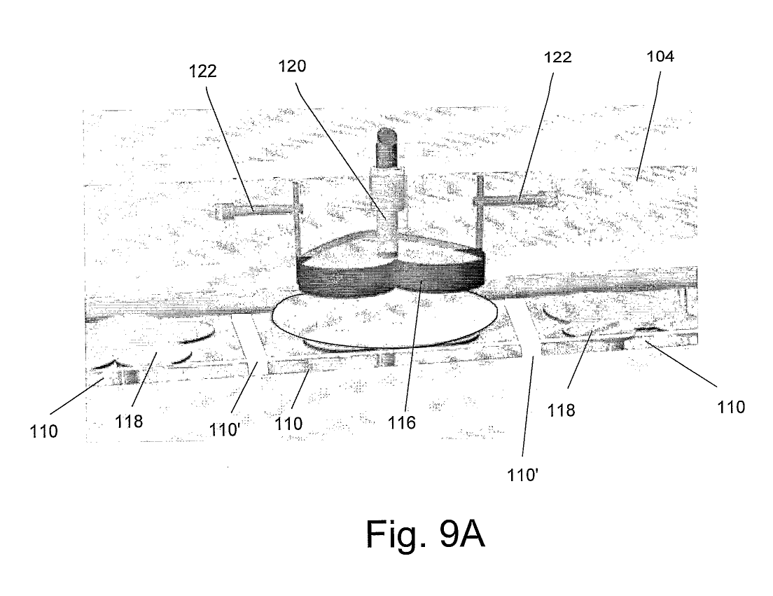

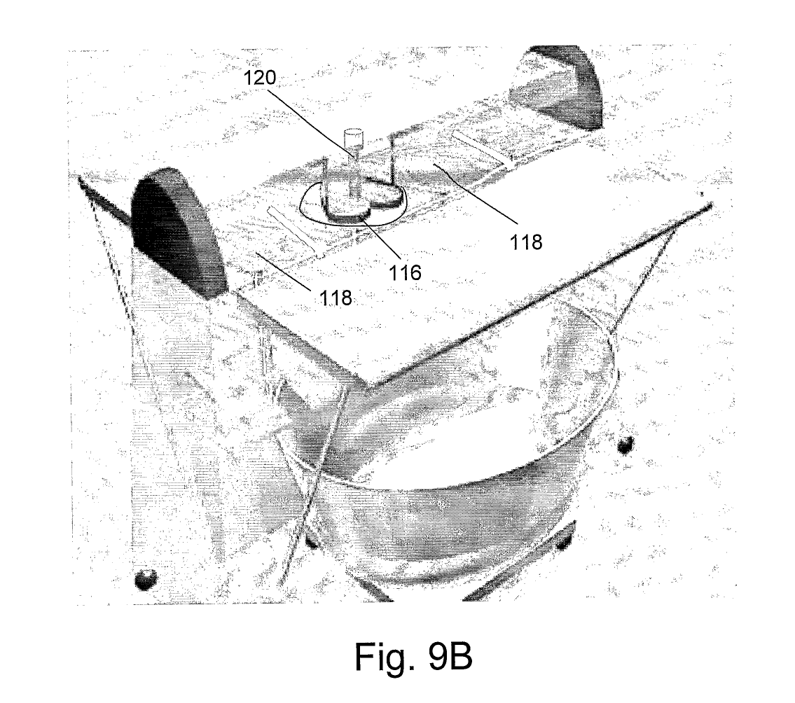

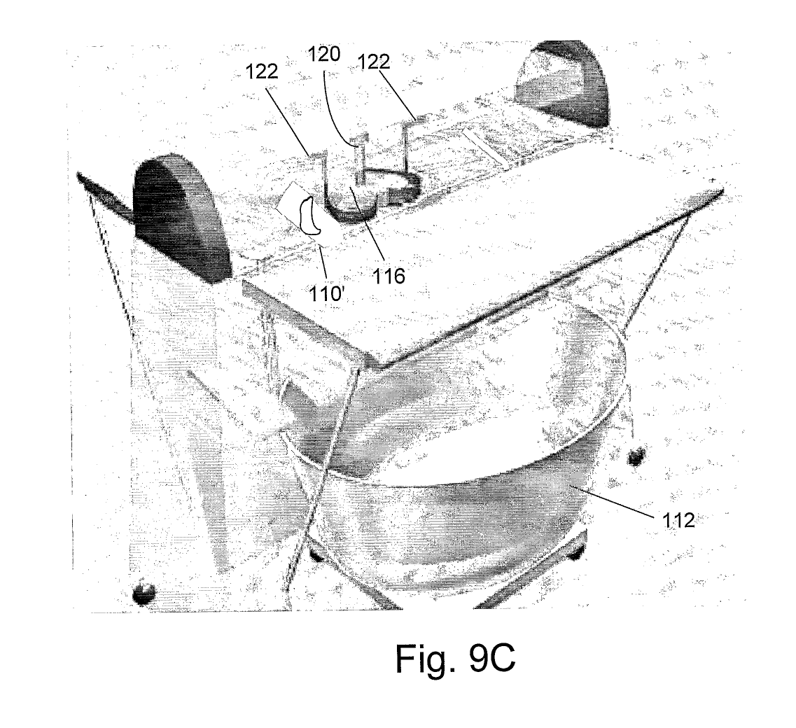

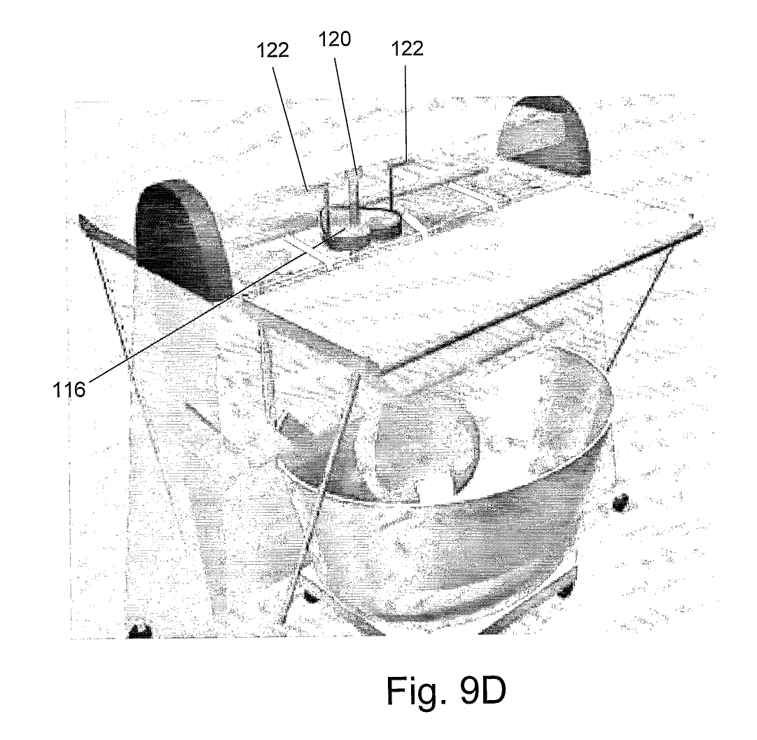

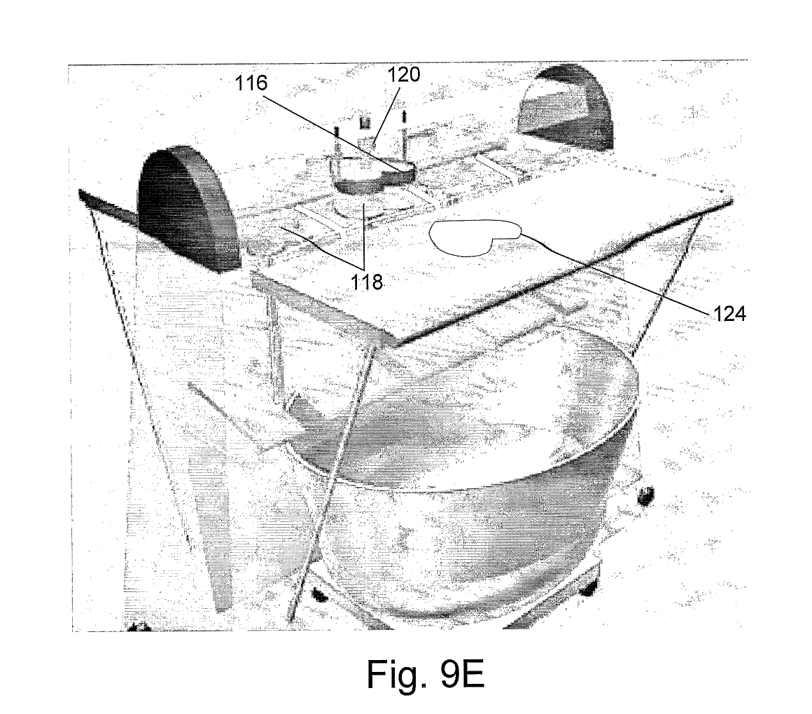

Cutting table 110 is not a continuous planar surface as shown in FIG. 7 and FIG. 8, but is actually comprised of a number of individual coplanar spaced apart surfaces as shown in FIGS. 9A-9E. The number of surfaces equals the number of punch assemblies 116. On each of the surfaces 110, centered under the punch assembly 116 is a low relief FIG. 118, which has the shape and orientation of the die on the bottom of the corresponding punch assembly 116.

Upper frame 104 supports piston assemblies for moving punch assembly 116 in three mutually perpendicular directions. Piston assembly 120 is analogous to piston assembly 36 described hereinabove and moves punch assembly 116 up and down in a vertical direction. A horizontal piston assembly analogous to piston assembly 42 is present but not shown in FIGS. 7 to 9E. This piston assembly moves punch assembly and attached piston assemblies 120 and 122 forwards and backwards from the table 110 to over the conveyor belt 108.

The major difference between the embodiments of the shaping machine described in FIG. 3 and that in FIG. 7 is in the construction of the punch assembly. The design of punch assembly 116 has many similarities to that of punch assembly 60 with three exceptions. Firstly, referring to FIG. 6A, cutting edge 62 defines the outer border of punch assembly 116. Secondly, punch assembly 116 is divided into two parts along a vertical plane through the center and aligned in the direction of motion of the dough through the machine. The two halves can be separated and rejoined to form a single unit by means of the two piston assemblies 122, which are attached to upper frame 104 and one of which is attached to each of the halves of the punch assembly 116. Thirdly, the external holes 66 in punch assembly 60 are absent in punch assembly 116 and the internal holes 68 are divided into two separate sets, each of which can be connected to either a compressor or a vacuum pump.

FIG. 9A to FIG. 9E schematically shows the steps in the shaping procedure using the shaping machine of FIG. 7 and FIG. 8. Referring to FIG. 7, conveyor 106 is slightly higher than table 110, so that when the disc of raw dough that comes from the flattening machine comes to the end of conveyor 106, it slides onto the top of the relief FIG. 118 on table 110. This is the situation shown in FIG. 9A. When a sensor that is provided for that purpose sends a signal to the control unit that the disc of dough is (or will shortly be) centered under the punch assembly 116 the next step, shown in FIG. 9B is initiated. In this step the piston assembly 120 is activated causing punch assembly 116 to descend until the die engages and cuts the dough.

After the dough is cut, piston assemblies 122 are activated, causing the two halves of the punch assembly to separate. As this takes place, they push the surplus dough to the side and it falls through spaces 110′ into the collection vessel 112. This step is shown in FIG. 9C, in which several narrow conveyor belts are shown conveying the surplus dough to the collection vessel. Other arrangements are possible, e.g. use of one wide collection belt or funnels. Immediately after separating the halves of punch assembly 116 to the maximum, piston assemblies 122 reverse direction causing the two halves of punch assembly 116 to move together, as shown in FIG. 9D. As the halves of the punch assembly get close to the shaped dough, the cutting edge 62 contacts the edges of relief FIG. 118, thereby insuring accurate alignment of the reassembled die with the shaped dough.

In the final step, shown in FIG. 9E, vacuum is applied through holes 68 to retain the shaped dough in the punch assembly while piston assembly 120 is activated to lift them off table 110 and the horizontal piston assembly is activated to move the m forward. When the punch assembly is over conveyor belt 108, it is lowered, the vacuum is replaced by a burst of air that gently releases the shaped dough 124 onto conveyor 108, and punch assembly 116 is returned to its starting position.

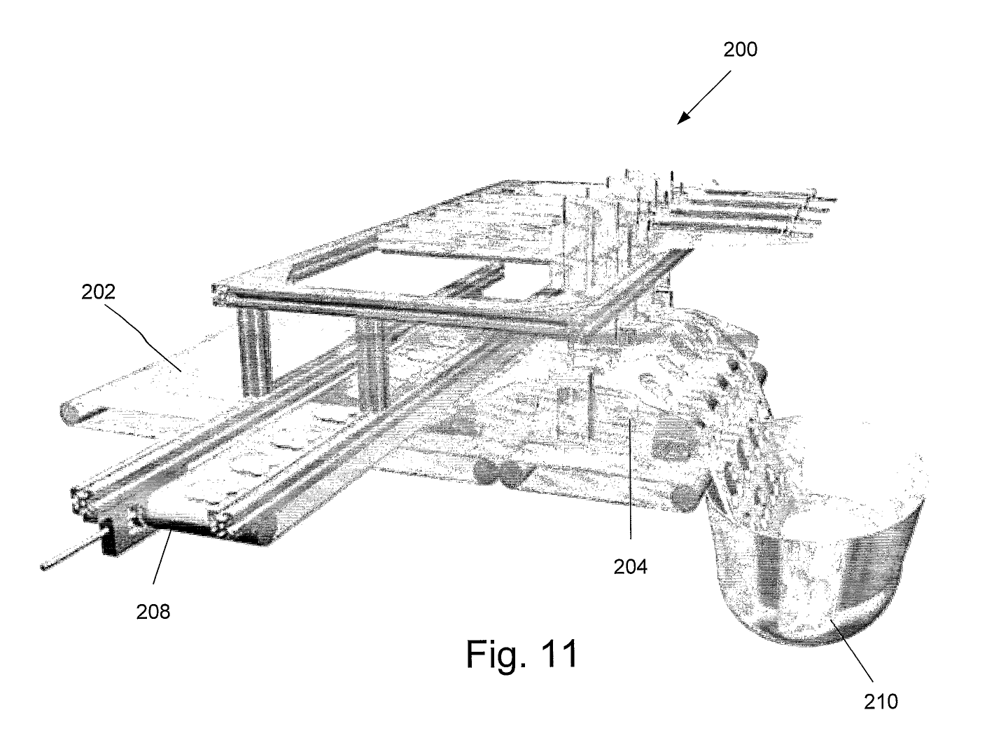

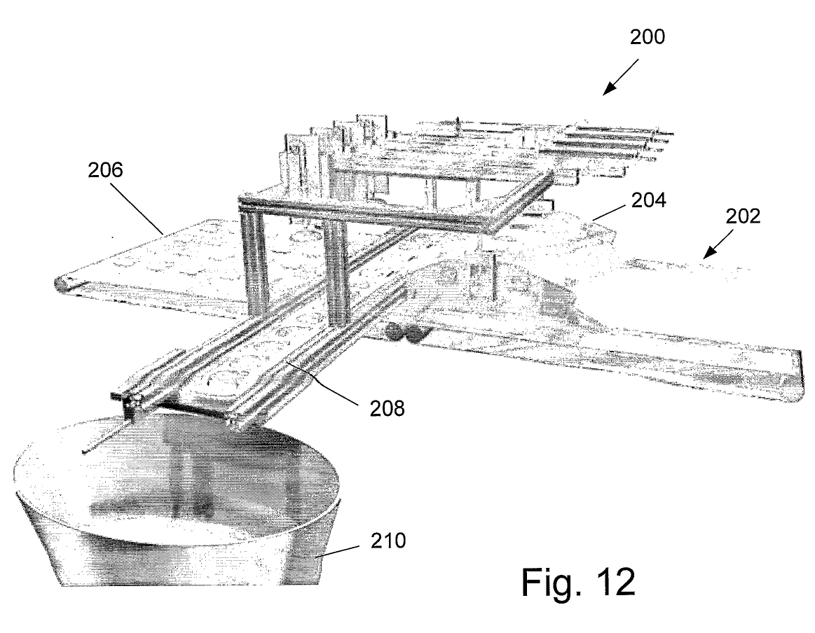

FIG. 11 and FIG. 12 show different configurations of an embodiment of the shaping machine of the invention used to cut the shaped pieces of dough out of a continuous sheet of raw dough. The piston assemblies, punch assemblies, bridge, and their operation are as described hereinabove. A sheet of raw dough is transported to the shaping machine 200 on conveyor belt 202 and rises onto bridge 204. The piston assemblies move down cutting out the shaped pieces of dough on the bridge. In FIG. 11 the shaped pieces of dough are lifted from the surface of the bridge by the piston and punch assemblies and transferred to conveyor belt 208, which transports them for further processing. At the same tine, the surplus dough moves off the bridge 204 and is transported to collection vessel 210 or to another machine in the processing line to be reused. In the embodiment shown in FIG. 12, the shaped pieces move off the bridge onto belt 206, while the surplus dough is sliced free of the remainder of the sheet by a knife (not shown in the figure) and lifted off the bridge 204 and onto belt 208 that transports it to collection vessel 210 or to another machine in the processing line to be reused.

Although embodiments of the invention have been described by way of illustration, it will be understood that the invention may be carried out with many variations, modifications, and adaptations, without departing from its spirit or exceeding the scope of the claims.

1. A machine for creating pieces of dough having a desired shape from unshaped raw dough comprising:
(a) a supporting frame;
(b) one or more punch assemblies each comprising one cutting edge having said desired shape on its bottom surface;
(c) one or more vertical piston assemblies to move said punch assemblies in a vertical direction;
(d) one or more horizontal piston assemblies to move said punch assemblies in a horizontal direction;
(e) a horizontal planar surface on which said unshaped raw dough is positioned in order to be shaped by said punch assembly;
(f) conveyor belts to transport said unshaped raw dough to said surface, to transport said pieces of dough having a desired shape to machines for further processing, and for transporting the surplus dough to be recycled;
(g) one or more sensors to determine the position of said unshaped raw dough relative to the center of said punch assemblies;
(h) a source of air at positive pressure;
(i) a source of suction; and
(j) a control system;
wherein, each of said punch assemblies comprises one or more arrays of holes each of said arrays connected to said source of air at positive pressure and/or said source of suction and by means of which dough can either be held to said bottom surface of said punch assembly by applying suction or released from said bottom surface of said punch assembly by applying air at positive pressure.

2. A machine according to claim 1, wherein the cutting edge divides the bottom surface of the punch assembly into two areas: an inner area, which corresponds to the shape and size of the shaped piece of dough; and an outer area, which corresponds to the surplus dough and the array of holes of said inner area can be activated independently of the array of holes of said outer area.

3. A machine according to claim 2, wherein the inner area is cut out and there is only an array of holes in the outer area.

4. A machine according to claim 2, comprising one or more additional cutting edges located within the interior area, wherein the area surrounded by each of said additional cutting edges comprises an array of holes.

5. A machine according to claim 1, wherein the cutting edge defines the outer border of the punch assembly, said punch assembly is divided into two parts, and said machine comprises, for each of the one or more punch assemblies, two piston assemblies for separating and reuniting said parts of said punch assembly.

6. A machine according to claim 5, comprising one or more low relief figure on the horizontal planar surface centered under each punch assembly and having the shape and orientation of the cutting edge on the bottom of the corresponding punch assembly.

7. A machine according to claim 1, wherein either the entire punch assembly or the component of the punch assembly comprising the cutting edge can be replaced with either another punch assembly or another component comprising a cutting edge having a different shape.

8. A machine according to claim 1, wherein the raw dough comprises pieces shaped like round discs and each of the horizontal and vertical piston assemblies is activated independently.

9. A machine according to claim 1, wherein the raw dough comprises a continuous sheet.

10. A machine according to claim 1, wherein the raw dough is for the production of pita bread and said machine can be integrated into any new or existing automatic or semi-automatic pita manufacturing production line.

11. A machine according to claim 1, wherein said machine is adapted such that it can be integrated into any existing automatic or semi-automatic bakery product manufacturing production line.

12. A machine according to claim 11, wherein the bakery product is selected from the group comprising:
(a) pizza;
(b) cookies;
(c) biscuits;
(d) tortias;
(e) fucacha;
(f) jabetta;
(g) pasta;
(h) mallach;
(i) fatut; and
(j) unleavened bread (matza).

13. A method for creating pieces of dough having a desired shape from unshaped raw dough comprising the steps of:
(a) providing an automatic or semi-automatic bakery product manufacturing production line;
(b) inserting a machine according to claim 1 into said line after the flattening machine, which creates flattened unshaped raw dough;
(c) activating the horizontal piston assemblies to move the punch assemblies over the horizontal planar surface;
(d) activating the vertical piston assemblies in response to a signal from the positioning sensor to move said punch assemblies downwards towards said horizontal planar surface, thereby cutting said unshaped raw dough into shaped pieces of raw dough and surplus dough;
(e) activating said punch assemblies, the corresponding vertical and horizontal piston assemblies, the source of air at positive pressure, and the source of suction to separate said pieces of dough having a desired shape from said surplus dough and transporting said shaped pieces to the next machine of said production line for further processing and transporting said surplus dough to be recycled.

14. A method according to claim 13, wherein the cutting edge divides the bottom surface of the punch assembly into an inner area, which corresponds to the shape and size of the shaped piece of dough and an outer area, which corresponds to the surplus dough; the array of holes in said inner area can be activated independently of the array of holes in said outer area; and step (e) comprises:
(i) causing air at a positive pressure to flow through said array of holes of said inner area;
(ii) activating the vertical piston assembly causing said punch assembly to be pulled upwards, said air flow thereby causing said shaped dough to separate from said punch assembly and remain on the horizontal planar surface;
(iii) simultaneously with step (i), activating the source of suction to cause negative pressure on the back side of said surplus dough outside said cutting edge, thereby causing it to adhere to said punch assembly;
(iv) as said punch assembly is raised off said horizontal planar surface, activating the horizontal piston assembly to move said punch assembly over the conveyor belt that transports said surplus dough to a storage vessel or machine for recycling;
(v) when said punch assembly is positioned over said conveyor belt, disconnecting said suction source from said array of holes of said outer area and causing air at a positive pressure to flow through them, thereby causing said surplus dough to be released from said punch assembly and to drop onto said conveyor.

15. A method according to claim 14, wherein the inner area is cut out and there is only an array of holes in the outer area and step (e) comprises:
(i) activating the vertical piston assembly causing said punch assembly to be pulled upwards, thereby causing said shaped dough to separate from said punch assembly and remain on the horizontal planar surface;
(ii) simultaneously with step (i), activating the source of suction to cause negative pressure on the back side of said surplus dough outside said cutting edge, thereby causing it to adhere to said punch assembly;
(iii) as said punch assembly is raised off said horizontal planar surface, activating the horizontal piston assembly to move said punch assembly over the conveyor belt that transports said surplus dough to a storage vessel or machine for recycling;
(iv) when said punch assembly is positioned over said conveyor belt, disconnecting said suction source from said array of holes of said outer area and causing air at a positive pressure to flow through them, thereby causing said surplus dough to be released from said punch assembly and to drop onto said conveyor.

16. A method according to claim 14, wherein the order of the activation of the positive pressure air flow and suction is changed, which causes the surplus dough to remain on the horizontal planar surface and the shaped dough to be transferred to another conveyor belt.

17. A method according to claim 14, in which the shaped pieces of dough can be provided with cut out areas by providing the punch assemblies with one or more additional cutting edges located within the interior area, wherein the area surrounded by each of said additional cutting edges comprises an array of holes.

18. A method according to claim 13, wherein: the cutting edge defines the outer border of the punch assembly; said punch assembly is divided into two parts; the machine comprises, for each of the one or more punch assemblies, two piston assemblies for separating and reuniting said parts of said punch assembly; and step (e) comprises:
(i) activating said two piston assemblies to separate said two parts of said punch assembly, thereby pushing the surplus dough off the horizontal planar surface onto a conveyor belt that transports said surplus dough to a storage vessel or machine for recycling;
(ii) activating said two piston assemblies to reunite said two parts of said punch assembly;
(iii) activating the source of suction to cause negative pressure on the back side of the shaped dough inside said cutting edge, thereby causing it to adhere to said punch assembly;
(iv) activating the vertical piston assembly causing said punch assembly to be pulled upwards;
(v) activating the horizontal piston assembly, thereby moving said punch assembly to a position over a conveyor belt that will transport said shaped dough to the next machine in the production line;
(vi) when said punch assembly is over said conveyor belt, activating said vertical piston assembly to lower said punch assembly close to the surface of said conveyor belt;
(vii) when said punch assembly is positioned over said conveyor belt, disconnecting said source of suction and causing air at a positive pressure to flow through the array of holes in said punch assembly, thereby causing said shaped dough to be released from said punch assembly onto said conveyor.

19. A method according to claim 13, wherein the raw dough comprises pieces shaped like round discs and each of the horizontal and vertical piston assemblies is activated independently.

20. A method according to claim 13, wherein the raw dough comprises a continuous sheet.

21. A method according to claim 13, wherein the raw dough is for the production of pita bread.
